(19) United States
(12) Patent Application Publication
(10) Pub. No.: US 2026/0104920 A1
(43) Pub. Date: Apr. 16, 2026

(54) TASK PROCESSING METHOD AND ELECTRONIC DEVICE

(71) Applicant: Lenovo (Beijing) Limited, Beijing (CN)

(72) Inventors: Yu ZHANG, Beijing (CN); Qianying WANG, Beijing (CN); Liuxin ZHANG, Beijing (CN)

(21) Appl. No.: 19/355,395

(22) Filed: Oct. 10, 2025

(30) Foreign Application Priority Data
Oct. 11, 2024 (CN) 202411418868.3

(51) Int. Cl. G06F 9/48

(52) U.S. Cl. CPC G06F 9/4881

(57) ABSTRACT

A task processing method includes obtaining a to-be-processed task, determining current task data of the to-be-processed task, determining a task scene to which the to-be-processed task belongs based on the current task data, determining a first user intention corresponding to the to-be-processed task and intention confidence based on the task scene, obtaining supplementary task data for the to-be-processed task based on the intention confidence, adjusting the first user intention based on the supplementary task data to obtain a second user intention, and generating a processing result for the to-be-processed task based on the second user intention.

### CROSS-REFERENCES TO RELATED APPLICATION

This application claims priority to Chinese Patent Application No. 202411418868.3, filed on October 11, 2024, the entire content of which is incorporated herein by reference.

### FIELD OF TECHNOLOGY

The present disclosure relates to the big data technology field and, more particularly, to a task processing method and an electronic device.

### BACKGROUND

With the development of large models, using the large models to perform user needs recognition for a smart task becomes an important method of processing the smart task. However, the existing user intention recognition method based on large models lacks human-like reasoning and planning capabilities. Thus, when the large models are used for scene tasks such as situational awareness and intention understanding, the recognition result may be unreliable, which limits the application range of the large model technology.

Thus, it is desirable to improve the accuracy of the large models in the scene tasks, such as situational awareness and intention understanding tasks, to expand the application range of the large models.

### SUMMARY

One aspect of this disclosure provides a task processing method. The method includes obtaining a to-be-processed task, determining current task data of the to-be-processed task, determining a task scene to which the to-be-processed task belongs based on the current task data, determining a first user intention corresponding to the to-be-processed task and intention confidence based on the task scene, obtaining supplementary task data for the to-be-processed task based on the intention confidence, adjusting the first user intention based on the supplementary task data to obtain a second user intention, and generating a processing result for the to-be-processed task based on the second user intention.

Another aspect of this disclosure provides an electronic device, including one or more processors and one or more memories. The one or more memories are communicatively connected to the one or more processors and store instructions that, when executed by the one or more processors, cause the one or more processors to obtain a to-be-processed task, determine current task data of the to-be-processed task, determine a task scene to which the to-be-processed task belongs based on the current task data, determine a first user intention corresponding to the to-be-processed task and intention confidence based on the task scene, obtain supplementary task data for the to-be-processed task based on the intention confidence, adjust the first user intention based on the supplementary task data to obtain a second user intention, and generate a processing result for the to-be-processed task based on the second user intention.

Another aspect of this disclosure provides a computer-readable storage medium storing a computer program that, when executed by one or more processors, causes the one or more processors to obtain a to-be-processed task, determine current task data of the to-be-processed task, determine a task scene to which the to-be-processed task belongs based on the current task data, determine a first user intention corresponding to the to-be-processed task and intention confidence based on the task scene, obtain supplementary task data for the to-be-processed task based on the intention confidence, adjust the first user intention based on the supplementary task data to obtain a second user intention, and generate a processing result for the to-be-processed task based on the second user intention.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic flowchart of a task processing method according to some embodiments of the present disclosure.

FIG. 2 is a schematic flowchart of an association logic link according to some embodiments of the present disclosure.

FIG. 3 is a schematic diagram showing task processing according to some embodiments of the present disclosure.

FIG. 4 is a schematic flowchart of another association logic link according to some embodiments of the present disclosure.

FIG. 5 is a schematic structural diagram of a task processing apparatus according to some embodiments of the present disclosure.

FIG. 6 is a schematic structural diagram of an electronic device according to some embodiments of the present disclosure.

### DETAILED DESCRIPTION

To make the purpose, features, and advantages of the present disclosure obvious and easy to understand, below, the technical solutions of embodiments of the present disclosure are described in detail in conjunction with the accompanying drawings in embodiments of the present disclosure. Apparently, the described embodiments are merely some embodiments of the present disclosure, not all embodiments. Based on embodiments of the present disclosure, all other embodiments obtained by those skilled in the art without creative efforts are within the scope of the present disclosure.

As the reasoning and planning abilities of user intention recognition methods based on large models are relatively weak, when large models are applied to scene tasks of situational awareness and intention understanding, the results may be unreliable. Thus, the application scope of the large model technology can be limited. Therefore, to improve the accuracy of the large models in the scene tasks, such as the situational awareness and intention understanding tasks, and expand the application scope of the large model technology, embodiments of the present disclosure provide a task processing method and an electronic device. The task processing method of embodiments of the present disclosure can be applied in a data processing scene, e.g., a virtual reality gaming scene or an office scene. The electronic device of the present disclosure can be a cell phone or a tablet computer.

Below, the technical solutions of embodiments of the present disclosure are described in detail in conjunction with the accompanying drawings of embodiments of the present disclosure.

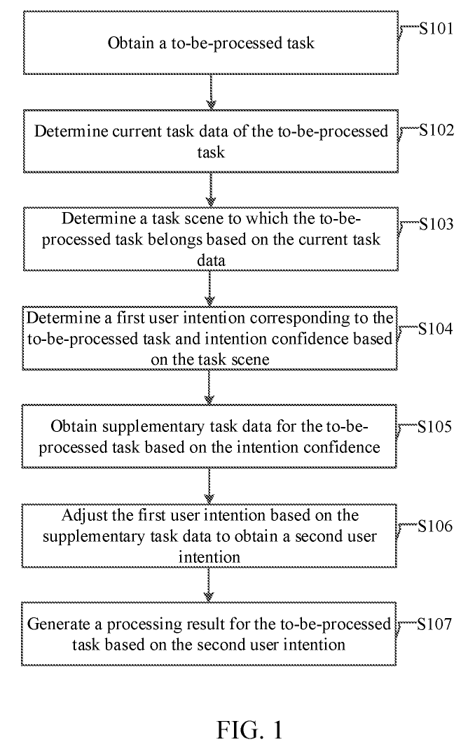

FIG. 1 is a schematic flowchart of a task processing method according to some embodiments of the present disclosure. The method includes the following processes.

At S101, a to-be-processed task is obtained.

In the present disclosure, the to-be-processed task can be a task that the user needs to process. The to-be-processed task can be a work task under any work scene in which the user may be involved. For example, the to-be-processed task can be daily work tasks such as replying to a characteristic email to a customer, formulating a meeting plan, and organizing work documents. The to-be-processed task can also be management tasks, such as evaluating project risks and tracking project progress. The to-be-processed task can also be finance-related tasks, such as formulating an annual budget and checking bills.

In the present disclosure, the tasks that are not processed by the user can be obtained by checking user emails every predetermined period, a project management tool, or a piece of work software as the to-be-processed task. The predetermined period can be 1, 6, or 12 hours.

In the present disclosure, the user can also, through a task trigger function, send the information of the to-be-processed task to the electronic device. In some embodiments, a task trigger key or a task trigger function option can be configured. A task information input interface can be displayed to the user when the user clicks the task trigger key or the task trigger function option. The user can input the to-be-processed task in the interface. The task input by the user can be obtained as the to-be-processed task.

At S102, the current task data of the to-be-processed task is determined.

In the present disclosure, the current task data of the to-be-processed task can include at least one of a task type, a name of a belonging project, a task name, a task description content, a task deadline date, a task priority, and a task processing progress of the to-be-processed task.

In the present disclosure, the current task data of the to-be-processed task can be extracted by recognizing keywords, or the data of the to-be-processed task can be filtered through a filter option such as the task deadline data or the priority of the to-be-processed task. In the present disclosure, the currently related data of the to-be-processed task can be input to the task processing model. The task processing model can be configured to extract the current task data of the to-be-processed task. The task processing model can be obtained by training a to-be-trained model using a plurality of sample tasks and sample task processing results.

At S103, a task scene to which the to-be-processed task belongs is determined according to the current task data.

In the present disclosure, the task scene to which the to-be-processed task belongs can be a project management scene, a meeting scene, or a customer communication scene.

In the present disclosure, different task scenes can correspond to different keywords. For example, the keywords corresponding to the meeting scene can include “meeting” and “conference”, and the keywords corresponding to the customer communication scene can include “email” and “telephone communication.” The task scene to which the to-be-processed task belongs can be determined by recognizing the keywords of the current task data. For example, the current task data of the to-be-processed task can include the task content description information of the to-be-processed task “email sent by customer A.” The current task data can be recognized to include the keyword “email.” Then, the task scene to which the to-be-processed task belongs can be determined as the customer communication scene.

In some embodiments, the current task data can be input into an intention recognition model. The task scene to which the to-be-processed task belongs can be recognized by the intention recognition model.

In the present disclosure, features of the task data of the plurality of tasks of the task scenes can be pre-extracted through the intention recognition model as the scene features corresponding to the task scene, and the corresponding relationship between the task scene and the scene feature can be constructed. After the current task data is obtained, the features of the current task data can be extracted through the intention recognition model to match the features with the scene features of the task scenes. The scene corresponding to the scene feature corresponding to the highest matching degree can be determined as the task scene to which the to-be-processed task belongs. The intention recognition model can be obtained by pre-training the to-be-trained model with a plurality of sample tasks and user intentions corresponding to the sample tasks. The intention recognition model can be a processing block of the task processing model or an intelligent model independent of the task processing model.

At S104, a first user intention and an intention confidence corresponding to the to-be-processed task are determined based on the task scene.

In the present disclosure, the first user intention can reflect the processing target, processing decision, or processing result of the to-be-processed task desired by the user. The intention confidence can reflect the accuracy and reliability of the first user intention relative to the true intention of the user.

In the present disclosure, the first user intention and the intention confidence of the first user intention can be obtained by analyzing the current task data through the combination of the task processing model and the task scene.

In the present disclosure, the task content information of the current task data under the task scene can be analyzed in combination with the task scene. The task processing decision corresponding to the to-be-processed task can be predicted according to the task content information. The task processing decision can include task processing processes corresponding to one or more processing tasks, e.g., the to-be-processed task for sending email to customer A. Execution process S1 of obtaining email em of customer A, execution process S2 of generating email content T, and execution process S3 of sending content T to email em to obtain the customer email can be determined based on the to-be-processed task. Execution processes S1 to S3 can be determined as the first user intention of the to-be-processed task.

In the present disclosure, the intention confidence of the first user intention can be determined through the task scene to which the to-be-processed task belongs and the context information of the current task data of the to-be-processed task. The context information of the current task data can include the data of the to-be-processed task with the corresponding data generation time before the current task data and the data of the to-be-processed task with the corresponding data generation time after the current task data. For example, the intention confidence of the first user intention can be determined by analyzing the matching degree of the scene involved with the first user intention and the task scene. In some other embodiments, the intention confidence can be determined by analyzing the association between the context information of the current task data and the first user intention.

In the present disclosure, history behavior data of the user can be obtained. The user preference can be analyzed based on the history behavior data. Then, the intention confidence of the first user intention can be determined by analyzing the association between the first user intention and the user preference.

At S105, according to the intention confidence, supplementary task data for the to-be-processed task is obtained.

In the present disclosure, the supplementary task data of the to-be-processed task can refer to the data of the task data related to the to-be-processed task that can influence the intention confidence. For example, the supplementary task data can include at least one of more detailed task description data, associated task data, or task attribute data corresponding to the to-be-processed task.

In some embodiments, obtaining the supplementary task data for the to-be-processed task to be processed according to the intention confidence can include processes A1 and A2.

At A1, whether the intention confidence corresponding to the first user intention is less than a predetermined confidence threshold is determined.

In the present disclosure, the predetermined confidence threshold can be set according to actual application needs, for example, 0.9 or 0.95.

At A2, if yes, the supplementary task data for the to-be-processed task is obtained.

If the intention confidence corresponding to the first user intention is less than the predetermined confidence threshold, the first user intention may be insufficient to reflect the true intention of the user. Thus, to determine a more accurate user intention, the related data of the to-be-processed task can be continuously obtained, i.e., the supplementary task data.

At S106, based on the supplementary task data, the first user intention is adjusted to obtain second user intention.

In the present disclosure, the supplementary task data can be analyzed through the combination of the task processing model and the task scene to adjust the first user intention to obtain the second user intention. For example, the first user intention can be “obtaining a sales report of product A before a first determined time.” The intention confidence of the first user intention can be lower than the predetermined confidence threshold. The supplementary task data can include the priority of product A being a highest level. The supplementary task data can be input to the task processing model. The first user intention can be adjusted in the combination of the task processing model and the priority of product A being the highest level to obtain the second user intention of obtaining the sales report of product A before the second determined time. The second determined time can be earlier than the first determined time. The intention confidence of the second user intention may not be lower than the pre-determined confidence threshold.

In the present disclosure, the first user intention can be adjusted through the task scene and the supplementary task data to obtain the second user intention. The intention confidence of the second user intention can be determined. If the second user intention is lower than the pre-determined confidence threshold, the supplementary task data of the to-be-processed task can be continuously obtained. The user intention can be continuously adjusted with the supplementary data until the intention confidence of the determined user intention is not lower than the pre-determined confidence threshold. The adjusted user intention can be determined as the second user intention.

At S107, according to the second user intention, the processing result for the to-be-processed task is generated.

In the present disclosure, the processing result of the to-be-processed task generated according to the second user intention can include a processing decision of performing or solving the to-be-processed task. In some other embodiments, the processing result of the to-be-processed task generated according to the second user intention can also include a task execution result generated after performing the processing decision corresponding to the processing result of the to-be-processed task generated according to the second user intention can include task.

In some embodiments, generating the processing result for the to-be-processed task according to the second user intention can include processes B1 and B2.

At B1, a processing strategy corresponding to the to-be-processed task is generated according to the second user intention.

In the present disclosure, the processing strategy corresponding to the to-be-processed task can include at least one of a working type that needs to be performed by the user, a material type that needs to be prepared by the user, a platform type that is obtained to be processed can be at least one of the strategies such as the type of work the user needs to execute, the material acquisition platform type needed by the user, or a workflow that needs to be executed by the user.

In the present disclosure, the user can execute the processing strategy based on the working personnel corresponding to the processing strategy assignment. The obtained execution result can be used as the processing result of the to-be-processed task. In some other embodiments, the execution result of the to-be-processed task can be obtained by executing the processing strategy through the task processing model.

In the task processing method of the present disclosure, after the to-be-processed task is obtained, the task scene to which the to-be-processed task belongs can be determined according to the current task data of the to-be-processed task. The user intention can be analyzed in combination with the task scene. Whether the user intention is accurate can be analyzed through the intention confidence. When the user intention is not accurate enough, the supplementary task data can be obtained according to the intention confidence. The user intention can be adjusted in connection with the supplementary task data to obtain a more accurate user intention. Then, the processing result for the to-be-processed task can be generated by using the accurate user intention. That is, with the task processing method of the present disclosure, the accuracy in analyzing the user intention and the task processing can be improved.

In some embodiments, obtaining the supplementary task data for the to-be-processed task can include process C1.

At C1, target attribute information is displayed through a prompt interface to allow the user to supplement data corresponding to the target attribute information as the supplementary task data, or the data corresponding to the target attribute information is searched in a user database as the supplementary task data.

In the present disclosure, the target attribute information can be attribute information corresponding to data that can impact the intention confidence. In some embodiments, the data that can impact the intention confidence can include task scene description data of the to-be-processed task, task context data, and user demand data. The target attribute information of the data that can impact the intention confidence can include a data source, a data type, and a data storage position.

In the present disclosure, the prompt interface can be designed. The target attribute information can be displayed on the prompt interface to the user to allow the user to understand specific information of the supplementary task data that needs to be supplemented to guide the user to supplement the data. In some embodiments, a short description text can be added next to each piece of target attribute information displayed in the prompt interface to help the user understand the importance of the required information. For example, the target attribute information and the description text of the target attribute information of “Please supplement processing progress data of project A, e.g., processing progresses of modules of project A, and the data storage position being XX path” can be displayed on the prompt interface. The user can search the processing progress data of project A according to “XX path.” The processing progress data of project A can be used as the supplementary task data. In some other embodiments, the target attribute information and the description text of the target attribute information can be displayed in the prompt interface, and meanwhile, functional options corresponding to confirmation information and negative information can be displayed in the prompt interface. After the user clicks the functional option corresponding to the confirmation information, the corresponding data can be automatically searched in the database according to the storage position information in the target attribute information as the supplementary task data.

In some embodiments, the first user intention, the current task data, the supplementary task data, and the association logic link with the second user intention can be determined. The association logic link can be used to represent the logic of the user intention changing dynamically.

In the present disclosure, after the first user intention is adjusted to obtain the second user intention, the first reason of the first user intention and the current task data causing the intention confidence of the first user intention to be lower than the predetermined confidence threshold can be analyzed. Moreover, the supplementary task data and the second user intention can be used to improve the first result of the intention confidence. Logic association processing can be performed on the first reason and the first result to obtain the association logic link.

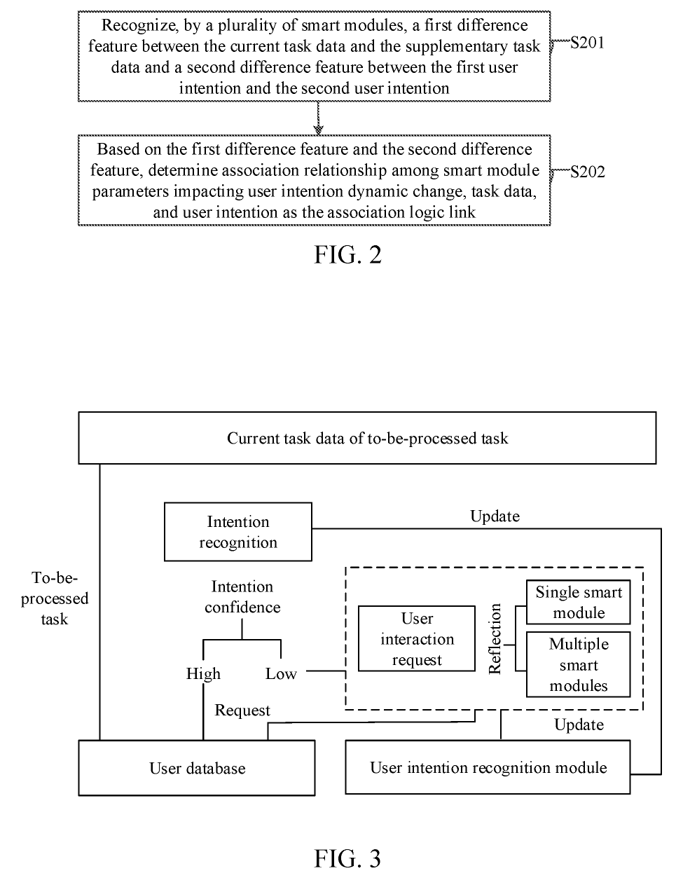

In some embodiments, FIG. 2 is a schematic flowchart of an association logic link according to some embodiments of the present disclosure. As shown in FIG. 2, determining the association logic link among the first user intention, the current task data, the supplementary task data, and the second user intention includes the following processes.

At S201, a plurality of smart modules are configured to recognize a first difference feature between the current task data and the supplementary task data and a second difference feature between the first user intention and the second user intention.

The smart modules can include a program related to the intention recognition function. Different smart modules can have different functions. Different smart modules can perform data interaction. For example, the smart modules can include an intention recognition program, a feature extraction program, a data pre-processing program, and a data integration program.

At S202, based on the first difference features and the second difference features, the association relationship among the smart module parameters impacting the user intention to change dynamically, the task data, and the user intention is determined as the association logic link.

In the present disclosure, the smart modules can be configured to analyze the difference features between the current task data and the supplementary task data and the difference feature between the first user intention and the second user intention. The smart modules can be configured to input the difference features obtained by analysis into the task processing model. The task processing model can be configured to integrate the association relationship among the smart module parameters impacting the user intention to change dynamically, the task data, and the user intentions. In some other embodiments, the modules can be analyzed through the association relationship, or the association relationship among the smart module parameters, the task data, and the user intention impacting the user intention to change dynamically can be analyzed.

In the present disclosure, the intention recognition capability of the task processing model can be continuously enhanced by using the association logic link. The data processing capabilities of the smart modules can be enhanced.

By analyzing the association logic link when the plurality of smart modules recognizes the user intention, the collaborative processing capability of the plurality of smart modules can be enhanced, and the intention capability of the task processing model can be enhanced to improve the accuracy of the intentions to improve the task processing capability.

FIG. 3 is a schematic diagram showing task processing according to some embodiments of the present disclosure. As shown in FIG. 3, for the to-be-processed task, the intention recognition can be performed by combining the current task data and the task scene of the to-be-processed task. When the intention confidence is high, the processing result of the task can be generated based on the user intention, and the processing result can be saved to the user database. When the intention confidence is low (e.g., lower than the predetermined confidence threshold), user interaction can be requested to obtain the task supplementary data from the user database. Based on the task supplementary data, the user intention can be further recognized. When the intention confidence is lower than the predetermined confidence threshold, a plurality of smart modules can reflect the reason causing the low intention confidence to obtain the association logic link. The association logic link can be updated to the user intention recognition module to enhance the intention recognition capability of the intention recognition model.

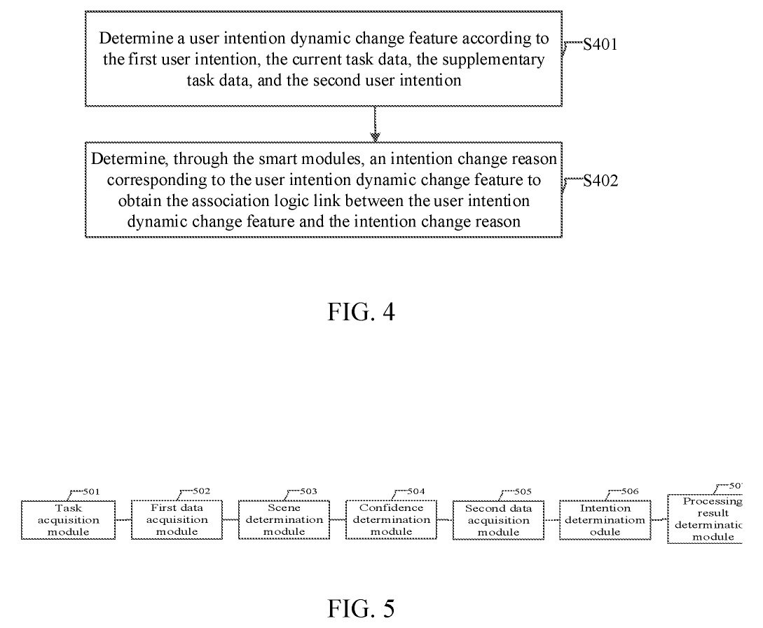

FIG. 4 is a schematic flowchart of another association logic link according to some embodiments of the present disclosure. As shown in FIG. 4, determining the associated logical link among the first user intention, the current task data, the supplementary task data, and the second user intention includes the following processes.

At S401, according to the first user intention, the current task data, the supplementary task data, and the second user intention, the user intention dynamic change feature is determined.

In the present disclosure, the intention change feature of the first user intention and the second user intention, and the difference data between the current task data and the supplementary task data can be analyzed to obtain the relationship between the difference data and the intention change feature as the user intention dynamic change feature.

At S402, through smart modules, the intention change reason corresponding to the user intention dynamic change feature is determined to obtain the associated logical link between the user intention dynamic change feature and the intention change reason.

The smart modules can refer to programs having functions related to intention recognition.

In the present disclosure, a single smart module can be configured to analyze the reason for the task processing model generating the user intention with a confidence lower than the predetermined confidence threshold according to the user intention dynamic change feature to obtain the association logic link between the user intention dynamic change feature and the intention change reason. The processing capability of the task processing model can be enhanced by using the association logic link.

A single smart module can analyze and reflect the logic link when recognizing the user intention. Thus, the formation of the thinking link for intention understanding can be enhanced to improve the accuracy of intention recognition to improve the task processing capability.

As shown in FIG. 3, when the intention confidence is lower than the predetermined confidence threshold, a single smart module also reflects the reason causing the intention confidence to be low to obtain the association logic link. The logic link can be updated to the user intention recognition module. The updated user intention recognition module can be associated with the intention recognition model to update the intention recognition model to enhance the intention recognition capability of the intention recognition model.

In the present disclosure, the user intention recognition module can be updated based on the association logic link. The user intention recognition module can be configured to recognize the user preference feature. The user intention recognition module can be used in association with the intention recognition model.

In the present disclosure, the user intention recognition module can be a processing program independent of the intention recognition model. By associating the user intention recognition module with the intention recognition model, the intention recognition model can call the processing result of the user intention recognition module. Thus, the processing capability of the task processing model can be enhanced.

In some embodiments, the association logic link can be updated to the user intention recognition module through a LoRA adapter (low-rank adaptation layer). By associating the user intention recognition module with the intention recognition model, the association logic link can realize adaptive hot-plugging on-demand access. With this manner, the adaptation to the task scene can be more flexible. Without affecting the output quality and performance of the task processing model for general tasks, the task processing model can enhance its own task processing capability by accessing the association logic link anytime.

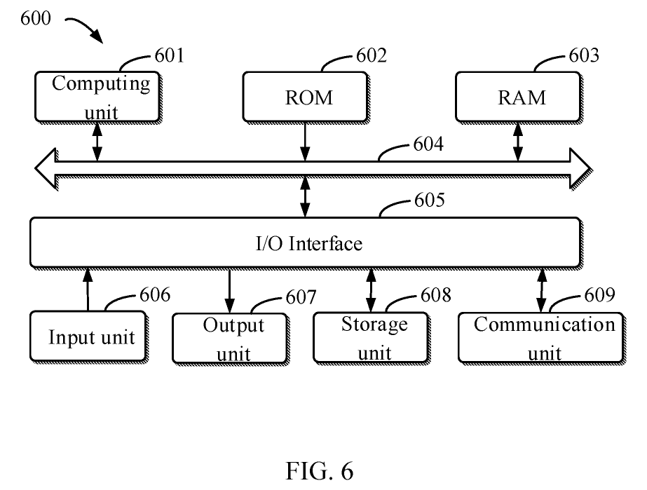

Based on the same inventive concept, according to the task processing method of embodiments of the present disclosure, correspondingly, embodiments of the present disclosure further provide a task processing apparatus. As shown in FIG. 5, the task processing apparatus includes a task acquisition module 501, a first data acquisition module 502, a scene determination module 503, a confidence determination module 504, a second data acquisition module 505, an intention determination module 506, and a processing result determination module 507.

The task acquisition module 501 can be configured to obtain the to-be-processed task.

The first data acquisition module 502 can be configured to determine the current task data of the to-be-processed task.

The scene determination module 503 can be configured to determine a task scene where the to-be-processed task belongs according to the current task data.

The confidence determination module 504 can be configured to determine the first user intention and the intention confidence corresponding to the to-be-processed task based on the task scene.

The second data acquisition module 505 can be configured to obtain the supplementary task data of the to-be-processed task according to the intention confidence.

The intention determination module 506 can be configured to adjust the first user intention based on the supplementary task data to obtain the second user intention.

The processing result determination module 507 can be configured to generate the processing result for the to-be-processed task according to the second user intention.

By using the task processing apparatus of the present disclosure, after the to-be-processed task is obtained, the task scene where the to-be-processed task belongs can be determined according to the current task data of the to-be-processed task. The user intention can be analyzed in connection with the task scene. Moreover, whether the user intention is accurate can be analyzed according to the intention confidence. When the user intention is not accurate enough, the supplementary task data can be obtained according to the intention confidence. The user intention can be adjusted in connection with the supplementary task data to obtain a more accurate user intention. Then, the processing result for the to-be-processed task can be generated using the accurate user intention. That is, with the task processing apparatus of the present disclosure, the accuracy of the user intention analysis and the task processing can be improved.

In some embodiments, the second data acquisition module 505 can be configured to display the target attribute information through the prompt interface to allow the user to supplement the data corresponding to the target attribute information as the supplementary task data. The target attribute information can be the attribute information corresponding to the data impacting the intention confidence. In some other embodiments, the data corresponding to the target attribute information can be searched in the user database as the supplementary task data.

In some embodiments, the apparatus can further include a logic link determination module (not shown in figures). The logic link determination module can be configured to determine the association logic link among the first user intention, the current task data, the supplementary task data, and the second user intention. The association logic link can be used to represent the logic of the user intention dynamic change.

In some embodiments, the logic link determination module can be applied to the plurality of smart modules to recognize the first difference feature between the current task data and the supplementary task data and the second difference feature between the first user intention and the second user intention. The smart module can refer to a program having a function related to intention recognition. Different smart modules can have different functions. The different smart modules can perform data interaction. Based on the first difference features and the second difference feature, the association relationship among the smart module parameters impacting the user intention dynamic change, the task data, and the user intentions can be determined as the association logic link.

In some embodiments, the logic link determination module can be configured to the user intention dynamic change feature according to the first user intention, the current task data, the supplementary task data, and the second user intention. Through the smart modules, the intention change reason corresponding to the user intention dynamic feature can be determined to obtain the association logic link between the user intention dynamic change feature and the intention change reason. The smart module can refer to a program that has a function related to intention recognition.

In some embodiments, the logic link determination module can be further configured to update the user intention recognition module based on the association logic link. The user intention recognition module can recognize the user preference feature. The user intention module can be applied with the intention recognition module.

In some embodiments, the scene determination module 503 can be configured to input the current task data into the intention recognition model. The task scene where the to-be-processed task belongs can be recognized by the intention recognition model.

In some embodiments, the processing result determination module 507 can be configured to generate the processing strategy corresponding to the to-be-processed task according to the second user intention and execute the processing strategy to obtain an execution result as the processing result of the to-be-processed task.

According to the task processing method of embodiments of the present disclosure, correspondingly, embodiments of the present disclosure further provide an electronic device. The electronic device can include one or more processors and one or more memories communicatively connected to the one or more processors.

The one or more memories can store instructions executable by the one or more processors. When the instructions are executed by the one or more processors, the one or more processors can be configured to obtain the to-be-processed task, determine the current task data of the to-be-processed task, determine the task scene where the to-be-processed task belongs according to the current task data, determine the first user intention and the intention confidence corresponding to the to-be-processed task based on the task scene, obtain the supplementary task data for the to-be-processed task according to the intention confidence, adjust the first user intention to the second user intention based on the supplementary task data, and generate the processing result for the to-be-processed task according to the second user intention.

Embodiments of the present disclosure further provide an electronic device and a readable storage medium.

FIG. 6 is a schematic structural diagram of an electronic device 600 according to some embodiments of the present disclosure. The electronic device can include various types of digital computers, such as laptop computers, desktop computers, workstations, personal digital assistants, servers, blade servers, mainframes, and other suitable computers. The electronic device can also include various forms of mobile apparatuses, such as personal digital processors, cellular phones, smart phones, wearable devices, and other similar computing apparatuses. The components of the present disclosure, the connections and relationships of the components, and the functions of the components are merely exemplary and do not limit the description and/or implementations of the present disclosure.

As shown in FIG. 6, the device 600 includes a computing unit 601. The computing unit 601 can perform various suitable actions and processes according to the computer program stored in the read-only memory. Various programs and data required by the operation of the device 600 can be stored in the RAM 603. The computing unit 601, the ROM 602, and the RAM 603 can be connected to each other through bus 604. Input/Output (I/O) interface 605 is also connected to bus 604.

A plurality of components of the device 600 can be connected to the I/O interface 605, and include an input unit 606, e.g., keyboards, mouses, etc., an output unit 607, e.g., various types of displays, speakers, etc., a storage unit 608, e.g., disks, optical discs, etc., and a communication unit 609, e.g., network cards, modems, wireless communication transceivers, etc. The communication unit 609 can allow the device 600 to exchange information/data with other devices through computer networks such as the Internet and/or various telecommunication networks.

The computing unit 601 can include various general-purpose and/or special-purpose processing assemblies having processing and computing capabilities. For example, the computing unit 601 can include, but is not limited to, a central processing unit (CPU), a graphics processing unit (GPU), various dedicated artificial intelligence (AI) computing chips, various computing units running machine learning model algorithms, a digital signal processor (DSP), and any appropriate processors, controllers, microcontrollers, etc. The computing unit 601 can be configured to execute the various methods and processing described above, for example, the task processing method. For example, in some embodiments, the task processing method can be implemented as a computer software program, which is tangibly included in a machine-readable medium, such as a storage unit 608. In some embodiments, part or all of the computer program can be loaded and/or installed onto the device 600 via the ROM 602 and/or the communication unit 609. When the computer program is loaded into the RAM 603 and executed by the computing unit 601, one or more steps of the task processing method described above can be executed. Alternatively, in other embodiments, the computing unit 601 can be configured to execute the task processing method in any other appropriate methods (e.g., with the help of firmware).

Various embodiments of the systems and technologies described above of the present disclosure can be implemented in digital electronic circuit systems, integrated circuit systems, field programmable gate arrays (FPGA), application specific integrated circuits (ASIC), application specific standard products (ASSP), system on chip (SOC), complex programmable logic devices (CPLD), computer hardware, firmware, software, and/or combinations thereof. These various implementations can be implemented in one or more computer programs. The one or more computer programs can be executed and/or explained in a programmable system including at least one programmable processor. The programmable processor can be a special-purpose or a general-purpose programmable processor, which can receive data and commands from the storage system, at least one input apparatus, and at least one output apparatus and transmit the data and commands to the storage system, the at least one input apparatus, and the at least one output apparatus.

The program codes for implementing the method of the present disclosure can be written in any combination of one or more programming languages. These program codes can be provided to processors or controllers of general-purpose computers, special-purpose computers, or other programmable data processing apparatuses. Thus, when the program codes are executed by the processors or controllers, the functions/operations specified in the flowcharts and/or block diagrams can be implemented. The program codes can be completely or partially executed on a machine. The program codes can be used as an independent software pack, which can be partially executed on a machine and partially executed on a remote machine or completely executed on a remote machine or server.

In the context of the present disclosure, a machine-readable medium can be a tangible medium, which can include or store programs for use by or in combination with an instruction execution system, apparatus, or device. A machine-readable medium can be a machine-readable signal medium or a machine-readable storage medium. A machine-readable medium can include but is not limited to electronic, magnetic, optical, electromagnetic, infrared, or semiconductor systems, apparatuses, or devices, or any suitable combination thereof. More specific examples of the machine-readable storage medium can include electrical connections based on one or more wires, portable computer disks, hard disks, random access memory (RAM), read only memory (ROM), erasable programmable read only memory (EPROM or flash memory), optical fibers, portable compact disc read only memory (CD-ROM), optical storage devices, magnetic storage devices, or any suitable combination thereof.

To provide interaction with a user, the systems and technologies described herein can be implemented on a computer. The computer can include a display apparatus (e.g., a CRT (cathode ray tube) or LCD (liquid crystal display) monitor) for displaying information to the user and a keyboard and pointing apparatus (e.g., a mouse or trackball). The user can provide input to the computer through the keyboard and the pointing apparatus. Another type of apparatus can also be used to provide interaction with the user. For example, the feedback provided to the user can be any form of sensory feedback (e.g., visual feedback, auditory feedback, or tactile feedback) and receive the input from the user in any form (including auditory input, voice input, or tactile input).

The systems and technologies described herein can be implemented in computing systems including backend components (e.g., as data servers), or middleware components (e.g., application servers), or frontend components (e.g., user computers having graphical user interfaces or web browsers, through which the user can interact with embodiments of the systems and technologies described herein), or any combination thereof. The components of the system can be interconnected by any form or medium of digital data communication (e.g., a communication network). Examples of communication networks can include local area network (LAN), wide area network (WAN), and the Internet.

A computer system can include clients and servers. Clients and servers are generally remote from each other and typically interact through a communication network. The client and server relationship can be generated by running on the corresponding computer and the computer programs having the client-server relationship. The server can be a cloud server, a server of a distributed system, or a server combined with blockchain.

The above processes can be reordered, and steps can be added or deleted. For example, the steps of the present disclosure can be executed in parallel, sequentially, or in a different order, as long as the desired results of the technical solutions of the present disclosure can be achieved, which is not limited in the present disclosure.

In addition, the terms “first” and “second” are only for descriptive purposes, and cannot be understood as indicating or implying relative importance, or implicitly specifying the quantity of indicated technical features. Thus, features defined with “first” and “second” can explicitly or implicitly include at least one such feature. In the description of the present disclosure, the meaning of “a plurality of” can be two or more, unless otherwise explicitly specified.

The above are only some embodiments of the present disclosure. However, the scope of the present disclosure is not limited to this. Those skilled in the art can think of modifications or replacements within the technical scope of the present disclosure, which should be within the scope of the present disclosure. Thus, the scope of the present disclosure should be subject to the scope of the claims.

WHAT IS CLAIMED IS:

1. A task processing method comprising:
obtaining a to-be-processed task;
determining current task data of the to-be-processed task;
determining a task scene to which the to-be-processed task belongs based on the current task data;
determining a first user intention corresponding to the to-be-processed task and intention confidence based on the task scene;
obtaining supplementary task data for the to-be-processed task based on the intention confidence;
adjusting the first user intention based on the supplementary task data to obtain a second user intention; and
generating a processing result for the to-be-processed task based on the second user intention.

2. The method according to claim 1, wherein obtaining the supplementary task data for the to-be-processed task based on the intention confidence includes:
determining whether the intention confidence corresponding to the first user intention is less than a predetermined confidence threshold; and
in response to the first user intention being less than the predetermined confidence threshold, obtaining the supplementary task data for the to-be-processed task.

3. The method according to claim 1, wherein obtaining the supplementary task data for the to-be-processed task includes:
displaying target attribute information via a prompt interface to allow a user to supplement data corresponding to the target attribute information as the supplementary task data, the target attribute information being attribute information corresponding to data impacting the intention confidence; or
searching in a user database for data corresponding to the target attribute information as the supplementary task data.

4. The method according to claim 1, further comprising:
determining an association logic link among the first user intention, the current task data, the supplementary task data, and the second user intention, wherein the association logic link is used to indicate user intention dynamic change logic.

5. The method according to claim 4, wherein determining the association logic link among the first user intention, the current task data, the supplementary task data, and the second user intention includes:
recognizing, by a plurality of smart modules, a first difference feature between the current task data and the supplementary task data and a second difference feature between the first user intention and the second user intention, the smart modules referring to programs having functions related to intention recognition, different smart modules having different functions, and the different smart modules performing data interaction;
based on the first difference feature and the second difference feature, determining association relationship among smart module parameters impacting user intention dynamic change, task data, and user intention as the association logic link.

6. The method according to claim 4, wherein determining the association logic link among the first user intention, the current task data, the supplementary task data, and the second user intention includes:
determining a user intention dynamic change feature according to the first user intention, the current task data, the supplementary task data, and the second user intention; and
determining, through the smart modules, an intention change reason corresponding to the user intention dynamic change feature to obtain the association logic link between the user intention dynamic change feature and the intention change reason, the smart modules referring to programs having functions related to intention recognition.

7. The method according to claim 4, further comprising:
updating a user intention recognition module based on the association logic link, wherein the user intention recognition module is configured to recognize a user preference feature and is applied associated with an intention recognition model.

8. The method according to claim 1, wherein determining the task scene to which the to-be-processed task belongs according to the current task data includes:
inputting the current task data into an intention recognition model, and recognizing the task scene to which the to-be-processed task belongs through the intention recognition model.

9. The method according to claim 1, wherein generating the processing result for the to-be-processed task according to the second user intention includes:
generating a processing strategy corresponding to the to-be-processed task according to the second user intention; and
executing the processing strategy and using an obtained execution result as the processing result of the execution result task.

10. An electronic device comprising:
one or more processors; and
one or more memories communicatively connected to the one or more processors and storing instructions that, when executed by the one or more processors, cause the one or more processors to:
obtain a to-be-processed task;
determine current task data of the to-be-processed task;
determine a task scene to which the to-be-processed task belongs based on the current task data;
determine a first user intention corresponding to the to-be-processed task and intention confidence based on the task scene;
obtain supplementary task data for the to-be-processed task based on the intention confidence;
adjust the first user intention based on the supplementary task data to obtain a second user intention; and
generate a processing result for the to-be-processed task based on the second user intention.

11. The electronic device according to claim 10, wherein the one or more processors are further configured to:
determine whether the intention confidence corresponding to the first user intention is less than a predetermined confidence threshold; and
if yes, obtain the supplementary task data for the to-be-processed task.

12. The electronic device according to claim 10, wherein the one or more processors are further configured to:
display target attribute information via a prompt interface to allow a user supplement data corresponding to the target attribute information as the supplementary task data, the target attribute information being attribute information corresponding to data impacting the intention confidence; or
search in a user database for data corresponding to the target attribute information as the supplementary task data.

13. The electronic device according to claim 10, wherein the one or more processors are further configured to:
determine an association logic link among the first user intention, the current task data, the supplementary task data, and the second user intention, wherein the association logic link is used to indicate user intention dynamic change logic.

14. The electronic device according to claim 13, wherein the one or more processors are further configured to:
recognize, by a plurality of smart modules, a first difference feature between the current task data and the supplementary task data and a second difference feature between the first user intention and the second user intention, the smart modules referring to programs having functions related to intention recognition, different smart modules having different functions, and the different smart modules performing data interaction; and
based on the first difference feature and the second difference feature, determine association relationship among smart module parameters impacting user intention dynamic change, task data, and user intention as the association logic link.

15. The electronic device according to claim 13, wherein the one or more processors are further configured to:
determine a user intention dynamic change feature according to the first user intention, the current task data, the supplementary task data, and the second user intention; and
determine, through the smart modules, an intention change reason corresponding to the user intention dynamic change feature to obtain the association logic link between the user intention dynamic change feature and the intention change reason, the smart modules referring to programs having functions related to intention recognition.

16. The electronic device according to claim 13, wherein the one or more processors are further configured to:
update a user intention recognition module based on the association logic link, wherein the user intention recognition module is configured to recognize a user preference feature and is applied associated with an intention recognition model.

17. The electronic device according to claim 10, wherein the one or more processors are further configured to:
input the current task data into an intention recognition model, and recognize the task scene to which the to-be-processed task belongs through the intention recognition model.

18. The electronic device according to claim 10, wherein the one or more processors are further configured to:
generate a processing strategy corresponding to the to-be-processed task according to the second user intention; and
execute the processing strategy and use an obtained execution result as the processing result of the execution result task.

19. A computer-readable storage medium storing a computer program that, when executed by one or more processors, causes the one or more processors to:
obtain a to-be-processed task;
determine current task data of the to-be-processed task;
determine a task scene to which the to-be-processed task belongs based on the current task data;
determine a first user intention corresponding to the to-be-processed task and intention confidence based on the task scene;
obtain supplementary task data for the to-be-processed task based on the intention confidence;
adjust the first user intention based on the supplementary task data to obtain a second user intention; and
generate a processing result for the to-be-processed task based on the second user intention.

20. The computer-readable storage medium according to claim 19, wherein the one or more processors are further configured to:
determine whether the intention confidence corresponding to the first user intention is less than a predetermined confidence threshold; and
if yes, obtain the supplementary task data for the to-be-processed task.
